(19) United States
(12) Patent Application Publication
(10) Pub. No.: US 2007/0028785 A1
(43) Pub. Date: Feb. 8, 2007

(54) Bulb slicer

(76) Inventors: Gregory J. Foster, Chicago, IL (US); Robert W. Sheldon, Chicago, IL (US)

Correspondence Address: Paul E. Schaafsma;NovusIP, LLC, Suite 221, 521 West Superior Street, Chicago, IL, 60610, US

(21) Appl. No.: 11/196,106

(22) Filed: Aug. 3, 2005

(51) Int. Cl. A47J 17/00

(52) U.S. Cl. 99/537

(57) ABSTRACT

The present invention provides a bulb slicer for preferably slicing garlic and shallots. The bulb slicer includes a top portion, a base portion, and a slicing portion. The top portion includes a plurality of fingers extending downwardly from the underside of the top portion. The slicing portion includes a plurality of blades. The number of the plurality of fingers corresponds to the numbers of spaces between the plurality of blades, the width of the plurality of fingers corresponds to the width of the spaces between the plurality of blades; and the positioning of the plurality of fingers corresponds to the position of the spaces between the plurality of blades. A gully defined above the slicing portion, the gully sized to cradle the bulbs in an orientation relative to the plurality of blades such that the bulb is sliced across the width rather than the length.

### FIELD OF THE INVENTION

The present invention relates to garlic and shallot slicing.

### BACKGROUND OF THE INVENTION

While known as the “Stinking Rose”, Garlic, scientifically known as allium sativum, is actually a member of the lily (Liliaceae) family and a cousin to onions, leeks, chives, and shallots. While because of the antiquity of garlic as a cultivated plant—the first use of garlic probably dates back 6,000 years—it is difficult with any certainty to trace the country of its origin, De Candolle considered that garlic was apparently indigenous to the southwest of Siberia, whence it spread to southern Europe, where it has become naturalized, and is said to be found wild in Sicily. De Candolle, Origin of Cultivated Plants. Garlic is a root crop, with the bulb growing underground. The bulb (the only part eaten) is of a compound nature, consisting of numerous bulblets, known technically as ‘cloves,’ grouped together between the membraneous scales and enclosed within a whitish skin, which holds them as in a sac.

For over 4,000 years, garlic has held many important roles in daily human life. It has been taken therapeutically and nutritionally. Folklore attributes garlic with good luck and protection against evil. The smell was said to ward off sorcerers, werewolves, warlocks, and-of course-vampires.

An Egyptian papyrus from 1,500 B.C. recommends garlic for 22 ailments. The Egyptians fed garlic to slaves building the pyramids, to increase their stamina. In ancient Greece and Rome, garlic was claimed to repel scorpions, treat dog bites and bladder infections, and cure leprosy and asthma. In the Middle Ages garlic was thought to prevent the plague.

Beyond superstition, modern research has confirmed the health benefits of garlic. Research in 1858, by Louis Pasteur, documented that garlic kills bacteria. During World War II, when penicillin and sulfa drugs were scarce, garlic was used as an antiseptic to disinfect open wounds and prevent gangrene. While the properties responsible for these medicinal effects are not clearly understood, recent research identifies hundreds of volatile sulfur compounds in the herb. Surprisingly, the way garlic is prepared appears to affect its healing qualities.

Medical studies have shown that garlic can lower cholesterol, prevent dangerous blood clots, reduce blood pressure, prevent cancer, and protect against bacterial and fungal infections. Just what makes garlic so good? Known scientifically as Allium sativum, garlic contains more than 100 biologically useful chemicals, including substances with such strange names as alliin, alliinase, allicin, S-allylcysteine, diallyl sulfide, allyl methyl trisulfide.

In fact, garlic has been used medicinally for at least 3,000 years, but until relatively recently its benefits were considered little more than folklore. According to a report in the Journal of the American Medical Association (Nov. 28, 1990; 264:2614), the therapeutic roles of garlic have been described in more than 1,000 scientific studies.

Jain reported that garlic can lower blood levels of “total” cholesterol and, particularly, of the dangerous low-density lipoprotein (LDL) form. American Journal of Medicine (June 1994; 94:632-5).

Garlic is also an anticoagulant—a natural blood thinner. Kieswetterfound that garlic could help patients suffering from peripheral arterial occlusive disease, characterized by blood clots in the legs. Clinical Investigator (May 1993; 71:383-6).

Why does garlic lower blood pressure? Blood pressure increases in response to the body's production of angiotensen I-converting enzyme (ACE). Some prescription blood pressure drugs work as “ACE inhibitors,” blocking formation of the chemical. Garlic contains gamma-glutamylcysteine, a natural ACE inhibitor. Planta Medica (Sendl, A. February 1992; 58:1-7).

Garlic also protects against cancer. Lau noted in Molecular Biotherapy (June 1991; 3:103-7), that garlic “is one of the most ancient of plants reputed to have an anticancer effect. As recorded around 1550 B.C., in the Ebers Papyrus, garlic was used externally for the treatment of tumors by ancient Egyptians and internally by Hippocrates and Indian physicians.”

Lau identified three ways garlic protects against cancer: by directly inhibiting tumor cell metabolism, by preventing the initiation and reproduction of cancer cells, and by boosting a person's immune system to more efficiently fight cancer cells.

Milner studied how aged garlic powder might protect against nitrosamine-induced cancers in laboratory mice. Nitrosamines are formed when processed meats, such as bacon and bologna are eaten. Milner found that a diet consisting of 2 to 4 percent garlic delayed the growth of breast cancer and reduced the number of tumors. Carcinogenesis (October 1992; 13:1847-51).

Another benefit was that levels of glutathione-S-transferase were 42 percent higher among the animals eating high-garlic diets. Glutathione-S-transferase is an enzyme that helps the liver detoxify carcinogens and other dangerous chemicals.

In a separate study, Milner found that garlic could dramatically reduce the number of “adducts” in deoxyribonucleic acid (DNA). Adducts are chemicals that attach nitrosamines to DNA, setting the stage for cancerous changes. Carcinogenesis (February 1994; 15:349-52).

Several studies have also shown that garlic reduces the risk of stomach cancer. Han found that garlic consumption was inversely related to the incidence of stomach cancer. Preventive Medicine (Han, J., September 1993; 22:712-22). Nagabhushan noted that diallyl sulfide significantly reduced stomach tumors in hamsters. Cancer Letters (Nagabhushan, M., Oct. 21, 1992; 66:207-16).

Scientific research has also confirmed garlic's role as a natural antibiotic. In 1983, Lau noted that “garlic extract has broad-spectrum antimicrobial activity against many genera of bacteria and fungi . . . . Because many of the microorganisms susceptible to garlic extract are medically significant, garlic holds a promising position as a broad-spectrum therapeutic agent.” Medical Hypotheses (12:227-37).

One way garlic works is by promoting phagocytosis, the ability of white blood cells to fight infections. Another is by stimulating other immune cells, such as macrophages and T-cells to fight bacterial and viral infections and to scavenge for cancer cells. One report described how garlic enhanced the body's “killer cell” activity against the AIDS virus. Deutsche Zeitschrift für Onkologie (April 1989; 21:52-3).

Lau has also noted that garlic can combat Candida infections. In one study, he injected an aged garlic extract into mice with Candida infections. After a day, the Candida colonies numbered 400, compared with 3,500 among the mice given only a salt-water solution. After two days, the garlic-treated mice were free of Candida.

Raw garlic, however, has very little biological activity. But when you “damage” garlic cloves—by slicing, cooking, or chewing—the enzyme alliinase immediately converts alliin into allicin, which gives garlic its characteristic odor. When garlic is heated, a different compound is formed that can prevent arteries from clogging, and reduce blood pressure and cholesterol levels. The blood-thinning quality of garlic may also be helpful in preventing heart attacks and strokes.

Allicin was once thought to be garlic's principal active ingredient. However, researchers now know that allicin is rapidly oxidized; more than 100 biologically active sulfur-containing compounds, proteins, and saponins are created as a result of this oxidation. While allicin may still serve as a general marker of garlic's potency, research increasingly points to S-allylcysteine and other compounds as the most therapeutically active ingredients in garlic.

Yet with all its health benefits, the quintessential use of the garlic is as a favoring agent for food. The clove can now be cooked whole, or it can be sliced, chopped, minced, or smashed. The intensity of flavor of fresh garlic depends upon how the garlic is prepared.

Raw garlic is quite strong, and is used extensively in dips and dressings for raw and cooked vegetables, and in specialty dishes like pesto, hummus and gazpacho. Sauteing is by far the most common and versatile method of cooking garlic, bringing out its nutty, savory taste and mellowing out the flavor. Poaching is another way of preparing garlic. Although it is not as often used as sautéing, it is sometimes preferred because it leaves the cloves whole and also because the garlic taste can be much more delicate. Oven roasting is a popular way of cooking garlic because it brings out the nutty flavor and adds an almost caramelized quality to the garlic. Grilling garlic is also an option and can be convenient when you have the grill going anyway. Frying garlic in oil gives you a crispy, nutty flavor that is well worth pursuing, but preparing it is tricky. While labor intensive, chopping bulbs, drying them, and processing them through a grinder results in garlic powder that can be stored and used for a long time.

Generally speaking, the more a clove of garlic is disassembled the stronger the flavor. Thus, if a clove of garlic is run through a garlic press or smashed under a chef's knife, a stronger flavor will result than with garlic that has been sliced or quartered. A roasted or simmered bulb will be even milder. In addition, the longer garlic is cooked, the milder the strength of its flavor. The longer it is cooked, the more mild it tastes; however, cooking garlic too long at too high a temperature will brown the garlic very quickly and leave the garlic tasting bitter.

Thus, to many garlic connoisseurs and chefs, the quintessential way to prepare garlic is to cross-sectionally slice the garlic across the length of the clove in micro-thin slices. Garlic presses separate the oil from the pulp, which minimizes flavor. Sliced garlic retains the oils and flavor. Many Professional chefs, like Mario Batali (Food Network Star, Author, and owner of seven successful restaurants), recommends slicing garlic in all of his recipes. (See, e.g. Basic Tomato Sauce: “4 garlic cloves, peeled and thinly sliced;” Caponata Of Eggplant: “2 cloves garlic, thinly sliced;” Calamari alla Luciana: “4 cloves garlic, thinly sliced;” Pollo Canzanese: “3 cloves garlic, sliced.” Available at http://64.233.167.104/search?q=cache:CD6X3Z21GbkJ:—www.wnyc.org/arts/articles/47340+Mario+Batali+garlic+recipes&hl=en (accessed 29 Jul. 2005). Slicing over pressing retains the full flavor and desirable texture as opposed to mashing (pressing) the clove. Testimony of the desirability of this technique is found in one of the most delicious cooking scenes in film (“Goodfellas” (Warner Bros., Inc., Director: Martine Scorsese 1990)), when Paulie Cicero, the mob boss played by the late Paul Sorvino, is shown slicing cloves of garlic with a razer blade into transparent planes so thin they “liquefy in the pan.” Paulie is serving time in a federal prison, so the message is when you have all the time in the world to prepare garlic, slice the garlic into transparent planes so thin they “liquefy in the pan.” What would therefore be desirable is to be able to slice the garlic into transparent planes so thin they “liquefy in the pan” when the user does not have all the time in the world to prepare garlic.

### SUMMARY OF THE INVENTION

A device in accordance with the principals of the present invention enables the slicing of garlic into transparent planes so thin they “liquefy in the pan” when the user does not have all the time in the world to prepare garlic. The present invention provides a bulb slicer for preferably slicing garlic and shallots. The bulb slicer includes a top portion, a base portion, and a slicing portion. The top portion includes a plurality of fingers extending downwardly from the underside of the top portion. The slicing portion includes a plurality of blades. The number of the plurality of fingers corresponds to the numbers of spaces between the plurality of blades, the width of the plurality of fingers corresponds to the width of the spaces between the plurality of blades; and the positioning of the plurality of fingers corresponds to the position of the spaces between the plurality of blades. A gully defined above the slicing portion, the gully sized to cradle the bulbs in an orientation relative to the plurality of blades such that the bulb is sliced across the width rather than the length.

### BRIEF DESCRIPTION OF THE DRAWINGS

FIG. 1 is a perspective view of a device in accordance with the principles of the present invention before use.

FIG. 2 is an elevational-side view of the device of FIG. 1 before use.

FIG. 3 is an elevational-front view of the device of FIG. 1 before use.

FIG. 4 is a perspective view of device of FIG. 1 with the top removed and cloves of garlic in the device.

FIG. 5 is a perspective view of device of FIG. 1 with the top replaced and cloves of garlic in the device.

FIG. 6 is an exploded perspective view of the device of FIG. 1.

FIG. 7 is an exploded perspective view of an alternative device in accordance with the principles of the present invention.

### DETAILED DESCRIPTION OF THE INVENTION

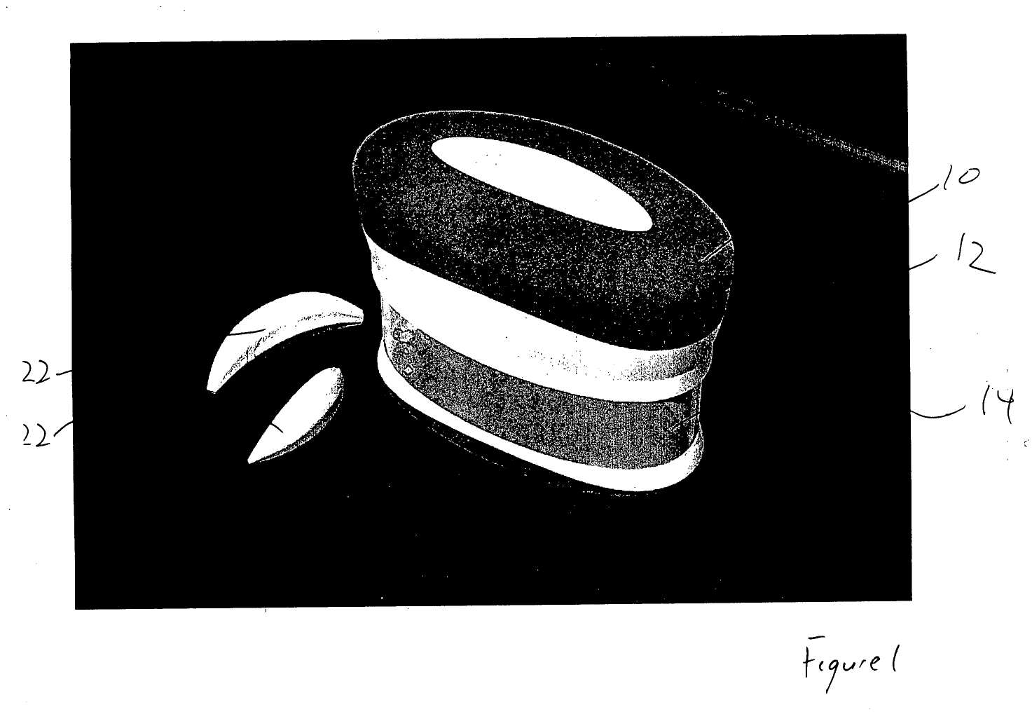

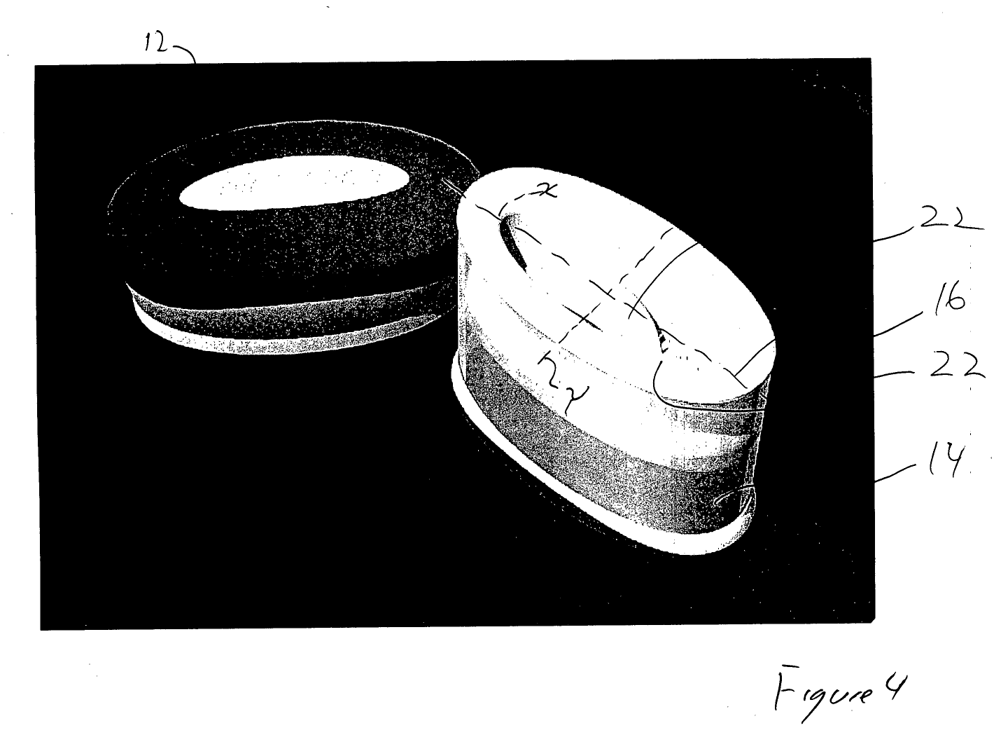

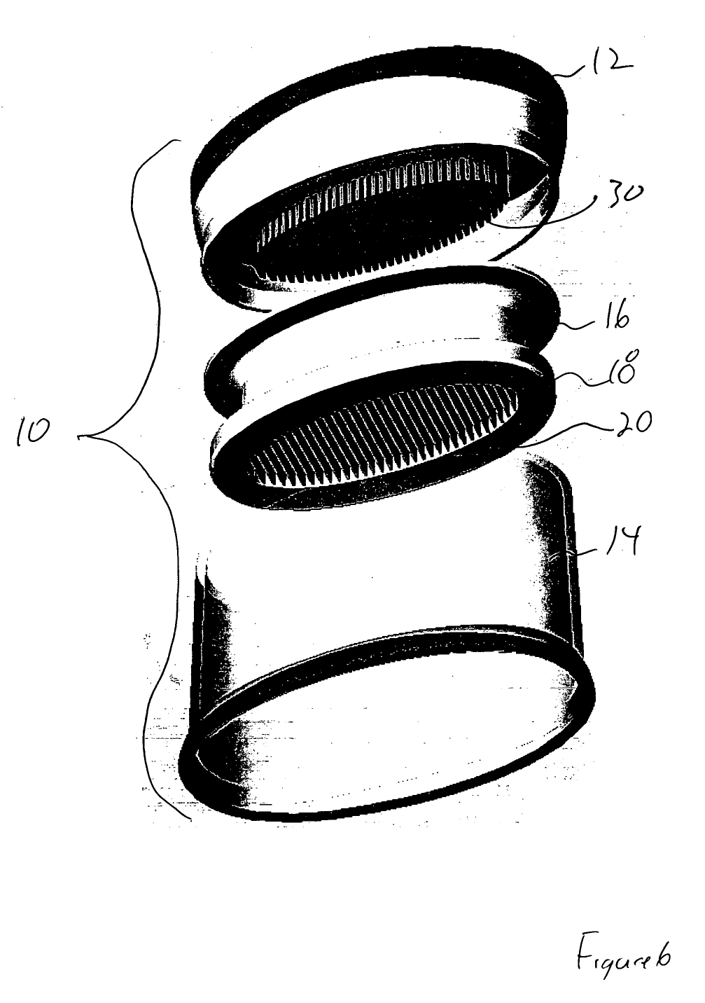

Referring to FIGS. 1-6, a device 10 in accordance with the principles of the present invention is seen. FIG. 1 is perspective view of a device in accordance with the principles of the present invention before use. The device 10 includes a top 12, a base 14, and a slicing portion 16 (seen in FIGS. 4-6). The slicing portion includes a frame 18 supporting a blade portion 20 (best seen in FIG. 6). The top 12, the base 14, and the frame 18 can be comprised of rigid or semi-rigid materials such as, for example, plastic, composite, ceramic or metal. In a preferred embodiment, the top 12, the base 14, and the frame 18 can be comprised of a clear plastic, which enables the user to see the bulbs in the device 10.

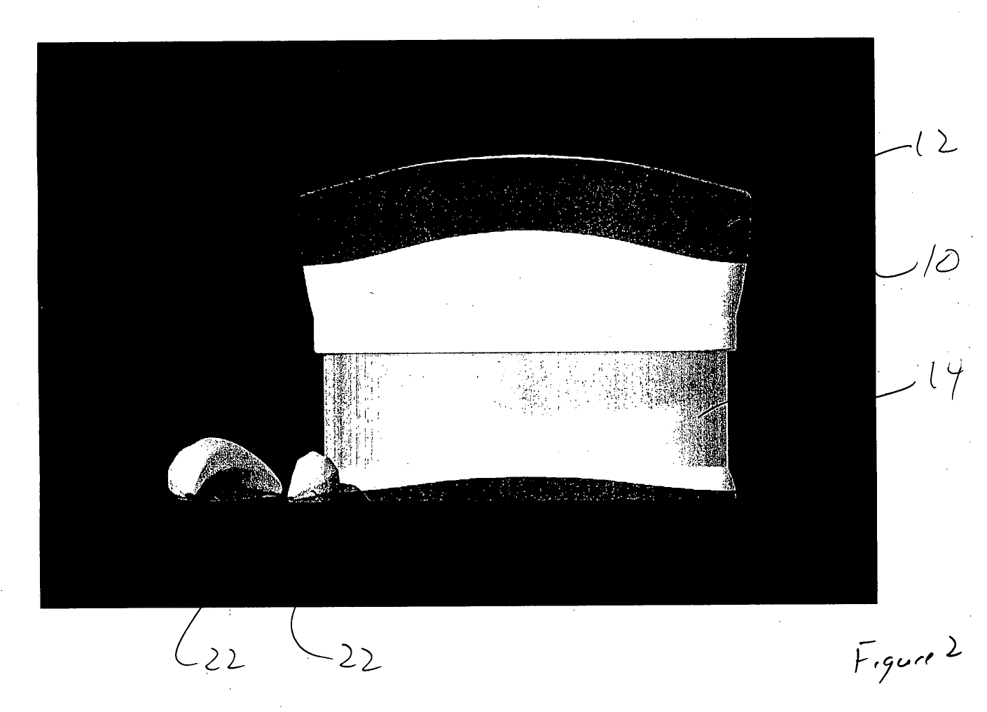

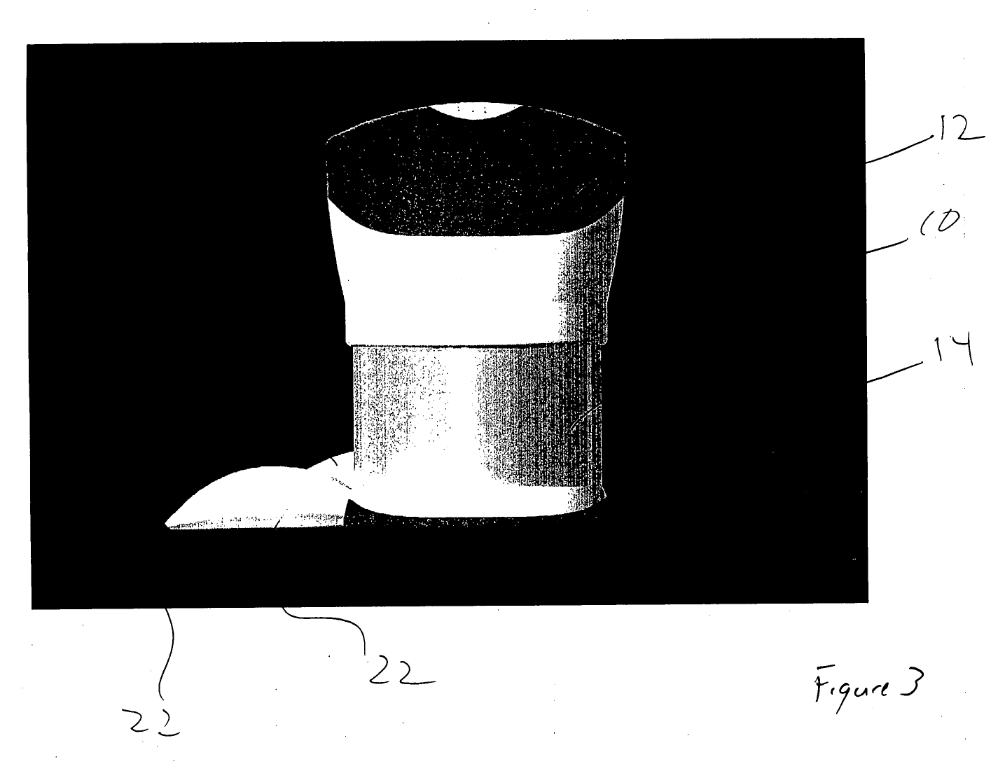

In a preferred embodiment, the top 12 of the devices comprised of an outer, non-slip covering such as for example rubber, which provides for a positive grip, and cushions the palm in operation. In a further embodiment, the base 14 is comprised of a non-skid bottom such as for example a thermoplastic elastomer that prevents unit from moving during operation. Referring to FIG. 4, a perspective view of device of FIG. 1 with the top 14 removed and cloves of garlic 22 in the device 10. While the embodiment of the device as described herein is used to slice cloves of garlic, it will be appreciated that the advantages of the device are equally applicable to shallots. The cloves of garlic 22 are cradled in a gully 25 defined in the frame 18 of slicing portion 16 above the blade portion 20. In one embodiment, the gully 25 can be preferably sized to accept one or two cloves of garlic for slicing which, in combination with the size of the blades discussed below provides an optimal slicing action. The gully 25 defines a major axis “x” and a minor axis “y”, with the major axis x and the minor axis y sized to assure that the cloves of garlic 22 roughly align with the major axis x. While not a requirement of the present invention, in one embodiment the device 10 itself replicates the shape of the gully 25, with the length of the device being in roughly the same proportion as the width of the device 10 as the major axis “x” and the minor axis “y”, as particularly seen in FIGS. 2 and 3. In one embodiment, the gully 25 is preferably 0.83 inches in width and 2.42 inches in length. An additional advantage to the shape of the device 10 is that the device 10 ergonomically fits easily into the hand of a user.

Referring to FIG. 6, an exploded perspective view of the device of FIG. 1 is seen. The exploded view of FIG. 6 generally depicts the exploded device 10 as viewed from the underside of the device 10. Under the gully 25 defined in the frame 18 of slicing portion 16 and extending across the length and width of the gully 25 are a plurality of blades 27. The plurality of blades 27 can be preferably made of a food-grade stainless steel although other materials that accomplish the slicing of the garlic are within the scope of the invention.

The blades 27 extend generally parallel with the minor axis “y” of the gully 25, thereby extending perpendicularly to the major axis “x” of the gully 25. Thus, the shape of the gully 25 that holds the cloves of garlic 22 combined with the orientation of the plurality of blades 27 ensures that each clove of garlic 22 will be cross-sectionally sliced across the length of the clove 22.

In one embodiment, the blade 27 dimensions are 0.02 inches thick by 0.25 inches tall with a 0.055 inch space between each blade. Surprisingly, such a shorter blade width allowed for a closer blade orientation to one another, producing a stronger overall blade which did not bend when pressing garlic through them. The wider and longer the blades are, the more unstable and “wobbly” the blades were, loosing structural strength. In addition, if the blades got wider and longer, the blades would have to be thicker which would in turn produce a thicker garlic slice. The thicker the blade, the more it would mash the garlic trying to pass through the blades, producing a thicker slice. Preferably, in one embodiment the blade 27 orientation provides a very thin 0.04 inch slice of garlic.

As also seen in FIG. 6, extending downwardly from the underside of the top 12 are a plurality of fingers 30. The number of the plurality of fingers 30 corresponds to the numbers of spaces between the plurality of blades 27; the width of the plurality of fingers 30 corresponds to the width of the spaces between the plurality of blades 27; and the positioning of the plurality of fingers 30 corresponds to the position of the spaces between the plurality of blades 27. The plurality of fingers 30 are preferably made of a hard, durable food-save material such as die cast metal. Thus, the plurality of fingers 30 push each clove of garlic 22 into and through the plurality of blades 27, and clean any residual garlic from between the blades 27.

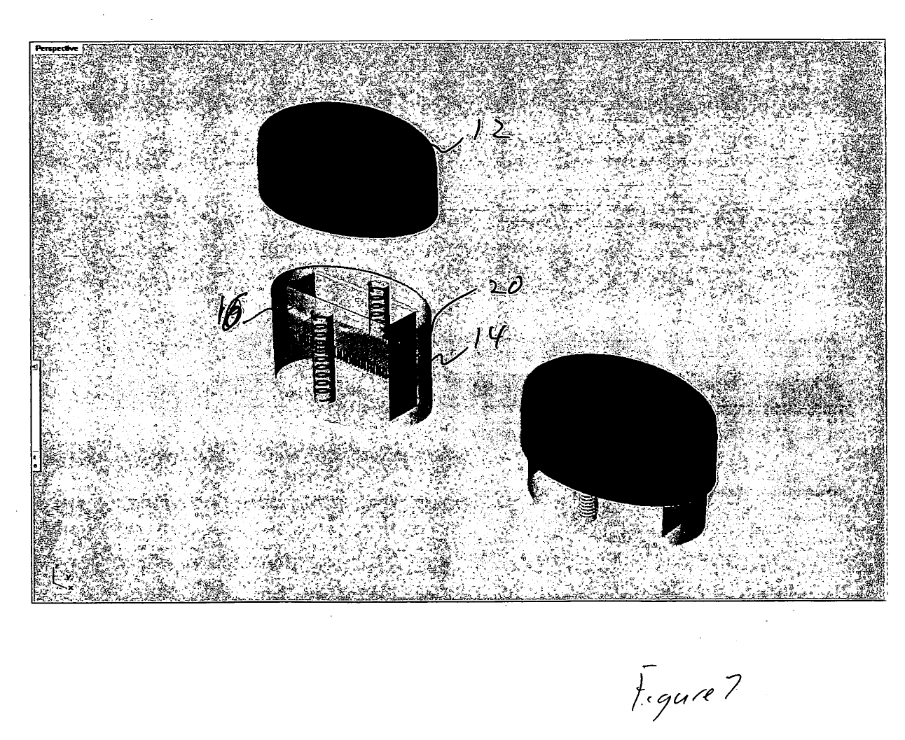

Referring to FIG. 7, an exploded perspective view of an alternative device in accordance with the principles of the present invention. The device 10 again includes a top 12, a base 14, and a slicing portion 16. In this alternative embodiment, an automated return mechanism such as a pair of springs 37 is provided. After the garlic has been sliced, this automated return mechanism automatically returns the top 12 to an upward position, thus enabling the slicing of a multiplicity of garlic cloves.

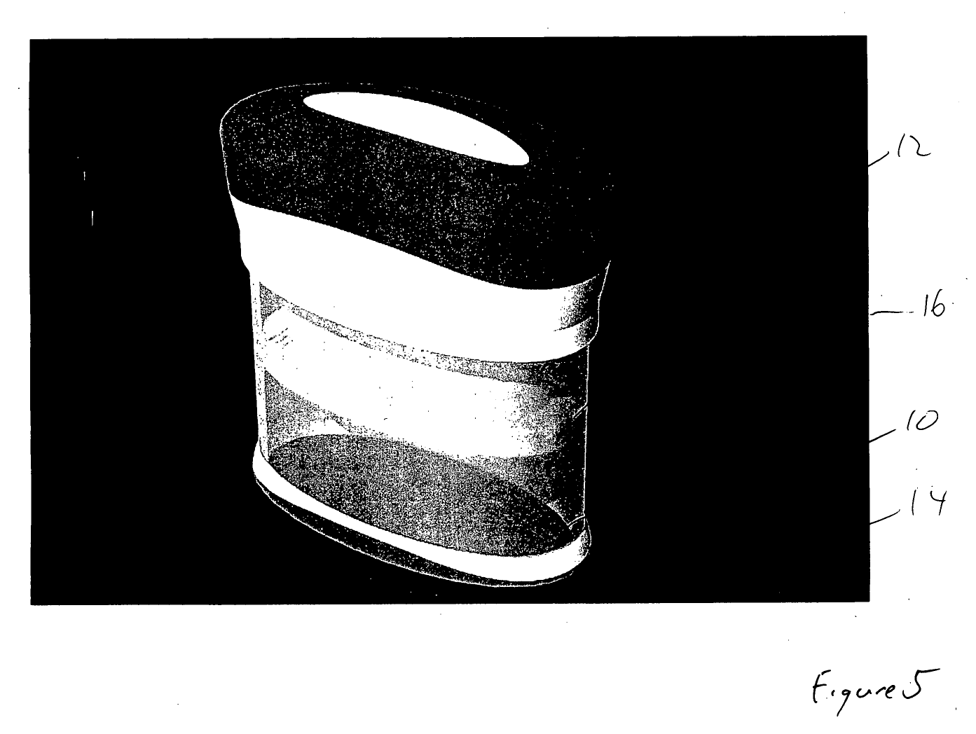

In use, the top 12 of the device 10 is removed and at least one clove of garlic 22 is placed in the gully 25, with the gully 25 positioning the clove(s) of garlic 22 roughly aligned with the major axis x of gully 25, as seen in FIG. 4. The top 12 is then replaced, as seen in FIG. 5, with the plurality of fingers 30 contacting the top of the clove(s) of garlic 22, which are resting in contact with and above the plurality of blades 27. By pushing downwardly on the top 12, the plurality of fingers 30 push the clove(s) of garlic 22 into and through the plurality of blades 27. Advantageously, the device allows for a quick, simple one-handed operation. In the alternative embodiment of the device seen in FIG. 7, after the garlic has been sliced, the automated return mechanism automatically returns the top 12 to an upward position, thus enabling the slicing of a multiplicity of garlic cloves. After the device 10 has been used, the construction of the device 10 enables an easy to clean system with just two pieces.

It should be understood that various changes and modifications to the preferred embodiments described herein would be apparent to those skilled in the art. Such changes and modifications can be made without departing from the spirit and scope of the present invention and without diminishing its attendant advantages. It is therefore intended that such changes and modifications be covered by the appended claims.

What is claimed is:

1. A bulb slicer comprising:
a top portion;
a base portion; and
a blade portion, the blade portion oriented to cut cutting the bulb across the width rather than the length.

2. The bulb slicer of claim 1 further comprising a frame supporting a blade portion.

3. The bulb slicer of claim 2 further including a gully defined in the frame above the blade portion, the gully sized to cradle at most two bulbs.

4. The bulb slicer of claim 2 further wherein the blade portion comprises a plurality of blades.

5. The bulb slicer of claim 4 further wherein each blade is 0.02 inches thick by 0.25 inches tall.

6. The bulb slicer of claim 2 further comprising a plurality of fingers extending downwardly from the underside of the top.

7. The bulb slicer of claim 2 further comprising a plurality of fingers extending downwardly from the underside of the top portion and the blade portion comprising a plurality of blades, the number of the plurality of fingers corresponds to the numbers of spaces between the plurality of blades, the width of the plurality of fingers corresponds to the width of the spaces between the plurality of blades; and the positioning of the plurality of fingers corresponds to the position of the spaces between the plurality of blades.

8. The bulb slicer of claim 1 further comprising an automated return mechanism that automatically returns the top portion to an upward position after the bulbs have been sliced.

9. The bulb slicer of claim 8 further wherein the automated return mechanism comprises a pair of springs.

10. The bulb slicer of claim 1 further wherein the top portion and the base portion comprise a clear material which enables the user to see the bulbs.

11. The bulb slicer of claim 1 further wherein the top portion comprises an outer, non-slip which provides for a positive grip and cushions the palm in operation.

12. The bulb slicer of claim 1 further wherein the bottom portion comprises a non-skid bottom that prevents unit from moving during operation.

13. The bulb slicer of claim 1 further wherein the bulb is garlic.

14. A bulb slicer comprising:
a top portion, the top portion including a plurality of fingers extending downwardly from the underside of the top portion; and
a slicing portion, the slicing portion including a plurality of blades, the plurality of blades oriented to cut cutting the bulb across the width rather than the length.

15. The bulb slicer of claim 14 further wherein the number of the plurality of fingers corresponds to the numbers of spaces between the plurality of blades.

16. The bulb slicer of claim 14 further wherein the width of the plurality of fingers corresponds to the width of the spaces between the plurality of blades.

17. The bulb slicer of claim 14 further wherein the positioning of the plurality of fingers corresponds to the position of the spaces between the plurality of blades.

18. The bulb slicer of claim 14 further including a gully defined above the plurality of blades, the gully sized to cradle at most two bulbs.

19. The bulb slicer of claim 14 further wherein each blade is 0.02 inches thick by 0.25 inches tall.

20. The bulb slicer of claim 14 further comprising an automated return mechanism that automatically returns the top portion to an upward position after the bulbs have been sliced.

21. The bulb slicer of claim 14 further wherein the bulb is sliced into slices less that 0.08 inches in width.

22. A bulb slicer comprising:
a top portion;
a slicing portion;
a gully defined above the slicing portion, the gully sized to cradle the bulbs in an orientation relative to the slicing portion such that the bulb is sliced across the width rather than the length.

23. The bulb slicer of claim 22 further wherein the slicing portion comprises a frame supporting a blade portion.

24. The bulb slicer of claim 23 further wherein the blade portion comprises a plurality of blades.

25. The bulb slicer of claim 24 further comprising a plurality of fingers extending downwardly from the underside of the top portion, the number of the plurality of fingers corresponds to the numbers of spaces between the plurality of blades, the width of the plurality of fingers corresponds to the width of the spaces between the plurality of blades; and the positioning of the plurality of fingers corresponds to the position of the spaces between the plurality of blades.
